(19) United States
(12) Patent Application Publication
(10) Pub. No.: US 2004/0030884 A1
(43) Pub. Date: Feb. 12, 2004

(54) System for controlling online and offline and offline access to digital data using a software key server

(76) Inventors: Jean-Yves Leroux, Ceyreste (FR); Laurent Jabiol, Ceyreste (FR)

Correspondence Address: GREENBLUM & BERNSTEIN, P.L.C., 1950 ROLAND CLARKE PLACE, RESTON, VA, 20191, US

(21) Appl. No.: 10/181,941

(22) PCT Filed: Jul. 6, 2001
(86) PCT No.: PCT/FR01/02174

(30) Foreign Application Priority Data
Jul. 6, 2000 (FR) 00/08838

(51) Int. Cl. H04L 9/00; H04K 1/00

(52) U.S. Cl. 713/150; 705/63; 725/25; 380/277

(57) ABSTRACT

The invention concerns a system for controlling online and offline access to digital data using a software key server. It consists in controlling access to encrypted digital data or programs broadcast by satellite, cable or digital land-based network, using a server of decryption keys (8) whereto each reception terminal (2) must be connected with a single identification through a secure channel independent of the transmission channel to be able to use the transmitted data or programs. Said system is generally applicable to all types of digital data transmission, and in particular digital television programs or encrypted data broadcasting services.

The present invention relates to a system for controlling online and offline access to digital data by means of a software key server.

Generally speaking, it relates to the field of transmission of all types of digital data, and particularly to digital television programs or services for broadcasting encrypted data.

Currently, access controls are used for protecting access to digital televisions packages. Each encrypted program can be deciphered by means of a chip having deciphering rights and generating the appropriate decoding keys by means of digital keys received through digital reception terminals.

In certain cases, for instance, when purchasing programs (usually movies), an upload channel, such as a telephone network, is used for billing or decrementing prepaid tokens, then assigning temporary rights to the chip which enables the user to watch the program or movie selected.

However, once the rights are acquired, deciphering occurs without a connection due to the keys recovered in the transmitted flow that also contains the encrypted services or programs. Thus, the service provider does not have access to the list of users (or chips) that continuously decipher his programs and, as a result, he has no way of knowing if a pirate chip is being used at a predetermined time.

The object of the system according to the present invention is to overcome these drawbacks. Indeed, it allows any provider of services, such as digital television or encrypted data, to know at any moment and therefore efficiently control the group of users accessing his services.

This system allows the provider to identify all of the users at any moment. Any pirate chip or system can be immediately identified due to the unicity of each open session, which is a necessary condition for recovering the keys. The method offers a solution that is more difficult to “pirate” than all of the current systems.

The system consists of controlling access to the encrypted digital data or programs broadcast by satellite, cable or a digital land-based network by means of a decryption key server to which each reception terminal must be connected with a single identification through a secured channel independent of the transmission channel in order to use the transmitted data or programs.

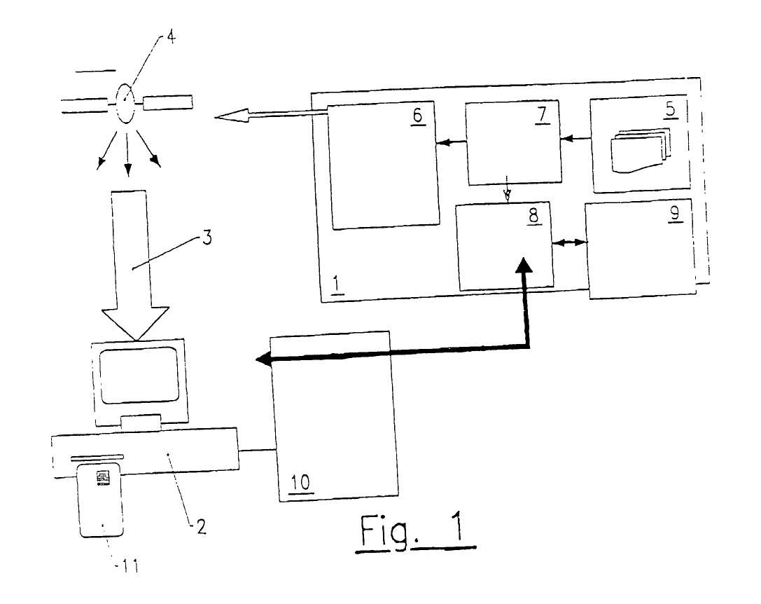

In the attached drawing that is given by way of non-limiting example of one of the embodiments of the object of the invention, FIG. 1 is a synoptic diagram of an assembly allowing the application of the proposed system.

The assembly according to FIG. 1 is constituted of a broadcast station 1 and terminals 2 receiving encrypted digital transmissions 3 transmitted, for example, by a satellite 4. The data 5 to be transmitted by the station 1 of the provider is sent to the satellite network due to an encrypted data server 6 after passing through an encrypting module 7.

Furthermore, the station 1 comprises a key server module 8 that is connected to an authorization controller 9 and linked to the telephone network 10.

A chip reader 11 is integrated with the reception terminal 2 or connected thereto.

The communication sessions, or sessions, are opened with the key server 8 that identifies the telephone and chip 11 numbers identifying the user and/or the internet address of the receiver 2. The authorization controller 9 determines whether or not to provide the decryption keys during the entire session based on the user's rights.

The system described can have the drawback of occupying a telephone line over an extended time frame, causing a high cost in communications and hindering users that have only one telephone line.

An intermediate solution consists of downloading several keys during each connection in a secured zone (for example, in the chip 11 itself), so as to free the line when using these keys. By way of example, a connection of several seconds per hour could be sufficient for loading the necessary keys during this time frame.

In addition, there are other means for connecting to servers, such as the new telephone coding systems (ADSL or VDSL), cable, or digital land-based broadcasting, as well as protocols for mobile telephones (GSM, GPRS, WAP, etc.), that do not allow monopolizing access as occurs with conventional telephone lines.

The system can allow non-subscribers to use a network of paying services on a pay-per-view basis. For instance, it can be possible to subscribe to one service or another for one hour, one day, one week. The cost can be higher than a traditional subscription, but it frees the user. Membership by payment with a bank card can also be envisioned. Thus, each operator has the option of providing access to any user without the latter being committed over a predetermined length of time, in a completely controlled manner, each transaction distinctly identifying each user.

Public terminals or multi-user receivers can allow everyone access to paying data and services, contrary to decoders placed in the user's home. Each user is given an access card (for example, a chip that can also be used as a payment card), or an access code and a password, or yet a biometric control, allowing him local access, for instance, from a hotel or a department store, to desired services. Each connection allows to manage and control a remote account for each user, giving more freedom and services to the users and allowing service providers to offer more controlled and secured services.

The system according to the invention can be used in the field of paying software (contracts, licenses) or equipment rentals.

Currently, the protection of fraudulent use of software generally occurs through software keys (serial number) or hardware keys (keys called dongles).

When applied to this field, the system makes the use of any connectable software or hardware to be completely controlled by the providers. It can be applied, for example, to the use of:

software paid for by the hour or by the day, the keys sent online allowing to maintain the software or one of its modules active. For instance, a portion of the software disappears when the keys are not received, making the software non-functional,

expensive work stations, large industrial machines, which prevents certain companies from having to purchase them, while controlling their use, and even the place of use due to the telephone number used,

individual computers placed “free of charge” directly in the user's home, or in public areas.

The principle can also be applied to controlling the use of hardware or software offline.

The user can either buy prepaid cards, or he can charge a card through an online connection. This card can allow a later use of a software or hardware without a connection.

For example, an individual computer placed free of charge in a user's home can function only if the appropriate card has sufficient credit.

This application can also be associated with a non-connected flow control: in order to use the hardware or software, the user must not only have sufficient credit, but during usage time or a portion thereof, he receives data through a download channel without a required upload channel (for instance, a satellite reception) which unlocks the hardware or software for use.

The charged card could give a receiving system the parameters necessary for filtering unlocking data. In comparison to unlocking systems that require an access code or a password, the user's credit gives the system the possibility and parameters required for receiving access codes or passwords transmitted by a remote system allowing the desired use.

The system according to the invention could also give rise to applications in the field of receiving devices that are completely portable, such as advanced mobile telephones (UTMS reception, advanced matrix display screen), or mobile “decoder-televisions”, equipped with a broadcast flow receiver and possibly wireless mono- or bi-directional upload channels.

The positioning of the various components gives the object of the invention a maximum of useful effects that, until now, had not been obtained by similar systems.

1. System for controlling online and offline access to digital data by means of a software key server, adapted to the transmission of encrypted digital data or programs broadcast by satellite, cable or a digital land-based network,
characterized in that the access control to digital transmissions (3) originating from a broadcasting station (1) occurs by means of a server for decryption keys (8) to which each reception terminal (2) must be connected with a single identification through a secured channel independent of the channel for transmitting the data or programs, in order to use said transmitted data or programs.

2. Access control system according to claim 1, characterized in that the broadcast station (1) is associated with a key server module (8) connected to an authorization controller (9).

3. Access control system according to claim 1, characterized in that the key server module (8) is linked to the reception terminal (2) by a telephone network (10).

4. Access control system according to claim 3, characterized in that several decryption keys are downloaded during each connection in a secured zone, such as a chip (11), so as to free the line during use of these keys.

5. Access control system according to any of the preceding claims, characterized in that it is arranged to allow non-subscribers to use a variety of paying services on demand, in a completely controlled fashion, each transaction distinctly identifying each user.

6. Access control system according to any of the previous claims, characterized in that the reception terminal (2) is connected to a chip reader (11), said chip allowing the identification of the user.

7. Access control system according to any of the previous claims, characterized in that it is arranged to allow the use of paying software, the keys sent online allowing to maintain the software or one of its modules active.

8. Access control system according to any of claims 1-6, characterized in that it is arranged to allow controlling the use of the connectable hardware.

9. Access control system according to any of claims 6-8, characterized in that it allows controlling the use of software or hardware offline due to a credit card (11) charged by means of an online connection.

10. Access control system according to claim 9, characterized in that it allows non-connected flow control, the user receiving data, during the time of use or a portion of this time, through a download channel without a required upload channel (for example, satellite reception) that unlocks the use of the hardware or of the software.

11. Access control system according to any of the preceding claims, characterized in that the reception terminal (2) is a multi-user type, allowing each user access to data and paying services, each user being provided with an access card, such as a chip (11) or an access code or a password, or yet subject to a biometric control, allowing him local access to the desired services.

12. Access control system according to claim 11, characterized in that each connection allows to manage and control a remote account for each user.

13. Access control system according to any of claims 11 and 12, characterized in that it allows controlling use of software or hardware offline due to a credit card (11) charged through an online connection.

14. Access control system according to any of claims 1 and 2, characterized in that it is adapted to be applied to portable apparatuses, such as advanced mobile telephones (UTMS reception, advanced matrix display screen), or mobile decoder-television sets, equipped with a broadcast flow receiver.

15. Access control system according to claim 12, characterized in that the portable apparatuses are equipped with wireless mono- or bi-directional upload channels.
